(19) United States
(12) Patent Application Publication
(10) Pub. No.: US 2006/0285813 A1
(43) Pub. Date: Dec. 21, 2006

(54) Fiber anchoring method for optical sensors

(76) Inventor: Stephen K. Ferguson, Lawrenceville, GA (US)

Correspondence Address: GREENLEE WINNER AND SULLIVAN P C, 4875 PEARL EAST CIRCLE, SUITE 200, BOULDER, CO, 80301, US

(21) Appl. No.: 11/452,094

(22) Filed: Jun. 12, 2006

Related U.S. Application Data
(60) Provisional application No. 60/689,246, filed on Jun. 10, 2005.

(51) Int. Cl. G02B 6/00

(52) U.S. Cl. 385/138; 385/137

(57) ABSTRACT

The invention relates generally to optical sensors that impart physical strain to an optical fiber by varying the tension applied axially to the fiber, which causes a change in the optical property of the light transmitted through the fiber. Methods, devices and device components for optical sensors are provided. The invention provides fiber holders capable of retaining a fiber under tension with little or no creep even in high temperature, high humidity environments. An exemplary fiber holder of the present invention provides superior retaining properties over epoxy and other adhesives while preserving the tensile strength of the original fiber. The invention further provides fiber holders and sensors, which are particularly useful for monitoring ambient conditions and measuring physical properties and mechanical phenomena.

### CROSS-REFERENCE TO RELATED APPLICATIONS

This application claims the benefit of U.S. provisional application 60/689,246 filed Jun. 10, 2005. This application is incorporated by reference herein in its entirety.

### BACKGROUND OF THE INVENTION

In the past few years, fiber optic based sensors have gained acceptance in the market as an alternative to conventional electronic sensors. In many applications, such as civil structure monitoring, down hole oil and gas applications, marine, and aerospace, fiber optic sensors offer several advantages over conventional sensors. Unlike electronic sensors, fiber-based sensors are immune to electromagnetic interference and are well suited to electrically noisy environments. Fiber-based sensors are also easily multiplexed, allowing many sensors to operate on a single fiber over long distances. Fiber-based sensors can be made very small and lightweight for use in confined spaces. Fiber-based sensors can be made to withstand high temperature and corrosive environments.

A wide variety of optical sensors are available that utilize various optical properties to measure the physical property of interest. The sensor is designed so that it will respond to the physical property to be measured by changing the amplitude, phase, polarization state, or other optical property of the light transmitted through the fiber. Depending on the sensor design, one or more of these optical properties can be monitored by an interrogation unit and converted to the physical property of interest.

The current invention focuses on sensor types that impart physical strain to a fiber by varying the tension applied axially to the fiber, which causes a change in an optical property of the light transmitted through the fiber. In this type of sensor, the fiber is often mounted in a mechanical fixture that converts the physical property to be measured into a mechanical displacement that varies the amount of strain present in the fiber. The method of mounting the fiber to the mechanical fixture is very important, if the sensor is to remain accurate over time. Any slippage or creep of the fiber relative to the mechanical fixture results in measurement drift.

Various epoxies and other adhesives are often used in fiber-based sensors to mount the fiber to the mechanical fixture. These adhesives often perform adequately in moderate temperatures and low humidity applications; however, as environmental conditions become more severe, adhesives tend to creep. Even in moderate conditions, creep may be a problem for applications requiring long-term stability.

U.S. Pat. No. 6,317,555 relates to a creep-resistant optical fiber attachment mechanism in which the cladding of the optical fiber has a “variation region (expanded or recessed) of an outer dimension.” The diameter of the cladding of the optical fiber is varied to provide the variation region which engages a portion of a ferrule to provide for attachment of the optical fiber in a ferrule. The fiber is said to be held in tension against the ferrule with minimal relative movement or creep. The ferrule may be attached to or part of a larger structure, such as a housing. A buffer layer may be positioned between the cladding and the ferrule to protect the fiber and help secure the fiber in the ferrule.

U.S. Pat. No. 6,768,825 describes optical sensors employing creep-resistant optical fiber attachment mechanisms of U.S. Pat. No. 6,317,555. The optical sensor contains an optical fiber with a Bragg grating in the core of the fiber for at least partially reflecting an optical signal at a characteristic wavelength. The senor device has two variation regions in the cladding of the optical fiber which are located on opposite sides of a Bragg grating to allow attachment of the optical fiber. The fiber attachments are mounted to a pressure sensitive structure to allow the characteristic wavelength to change according to pressure environment.

U.S. Pat. No. 6,726,371 relates to an apparatus for fixing a coated optical fiber to an optical fiber fixture. The fixing structure comprises a ferrule with a hole into which the optical fiber is inserted. The ferrule also comprises an opening from the side of the ferrule penetrating into the optical fiber insertion hole

A gutter-like optical fiber fixing component having optical fiber clamping parts is inserted into the opening and clamped onto the optical fiber to hold it in the ferrule.

U.S. Pat. No. 6,668,105 relates to a fiber optic sensor flatpack reported to be capable of extremely sensitive strain measurements. The patent provides packaging and packaging methods incorporating plastics materials and laminate manufacturing techniques to provide a hermetic package resistant to harsh environmental conditions.

U.S. Pat. No. 5,337,387 relates to methods for making hermetic fiber optic to metal components. A glass hermetic seal is formed between a metal shell and a metal-coated optical fiber. The method is described as useful for forming durable high hermeticity seals, but there is no teaching or suggestion that the method can be employed to form mechanically durable fiber to metal attachments for use in sensing applications in which the optical fiber is placed under tension.

U.S. Pat. No. 4,357,072 relates to a device for sealing an optical fiber into a light emitting diode package. A metallized fiber having a intervening metal collar is secured into a holder by melting a low-melting point substance, such as solder, around the fiber. The intervening metal collar is described as useful for positioning the fiber with respect to the light emitting diode. The patent states that “a relatively short length of non-metallised fibre can be used in which case low melting point glass is used as the material for the annulus.” However, it is not stated how the collar is provided when non-metalized fiber is employed. The collar is described as practically beneficial to make the fiber more rigid and heavier to allow quicker positioning of the fiber and to provide strength to withstand bending forces. The sealing method and device of this patent is described as useful for attaching and aligning an optical fiber with respect to a light emitting diode. There is no teaching or suggestion that the method and device employed can be employed to form mechanically durable fiber to metal attachments for use in sensing applications in which the optical fiber is placed under tension.

While several devices and methods for providing a seal for optical fibers are known in the art, there remains a need in the art for alternative methods and devices for mounting optical fibers into fixtures, particularly fo ruse in senor applications, which avoid or minimize creep.

### SUMMARY OF THE INVENTION

The invention provides an optical fiber retaining device comprising: a fiber holder having a bore or slot extending along the longitudinal axis of the fiber holder; an optical fiber that passes through the bore or slot in the fiber holder and which is oriented parallel to longitudinal axis of the fiber holder; and a glass or metal seal formed between the optical fiber and the holder which is formed at least partially within the bore or slot of the fiber holder. The seal can be formed of glass. In a specific embodiment, he optical fiber has a protective coating.

In a specific embodiment, the seal is formed between optical fiber and the fiber holder is formed over the protective coating of the fiber. In a specific embodiment, the glass seal material has a coefficient of thermal expansion greater than that of the optical fiber. In a further embodiment, the fiber holder material has a coefficient of thermal expansion greater than that of the glass seal material. In a specific embodiment a compression seal is formed. In another embodiment, the fiber holder material has a coefficient of thermal expansion substantially matched to that of the glass seal material. The fiber holder can be fabricated from stainless steel, Kovar, or Invar. In a specific embodiment, fiber holder has a seal-retaining cavity at least in part formed in the bore or slot of the holder. The fiber can have a protective coating that is a polyimide, carbon-polyimide, or carbon-Silicone-PFA. The fiber can have a metallic protective coating made of gold, copper, or aluminum. The sealing material can be a metal alloy, particularly when the protective coating is metal. The sealing material can be a metal alloy solder comprising lead, tin, silver, Indium, gold, or copper.

The optical fiber retaining device can further comprising a second fiber holder having an bore or slot extending along the longitudinal axis of the fiber holder; wherein the optical fiber with protective coating passes through the bore or slot in the second fiber holder and is oriented parallel to the longitudinal axis of the second fiber holder; and a second glass or metal seal formed around the optical fiber and at least partially within bore or slot of the fiber holder forming a seal between the coated optical fiber and the second fiber holder wherein the first and second fiber holders are spaced apart along the optical fiber forming two anchor points along the fiber.

The optical fiber retaining device can further comprises one or more additional fiber holders each having a bore or slot extending along the longitudinal axis of the fiber holder; wherein the optical fiber with protective coating passes through the bore or slot of each additional fiber holder and is oriented parallel to the longitudinal axes of each additional fiber holder; and for each additional fiber holder an additional glass or metal seal for each additional fiber holder formed around the optical fiber and at least partially within the bore or slot of the additional fiber holder forming a seal between the coated optical fiber and each of the additional fiber holders wherein the fiber holders are spaced apart along the optical fiber forming a plurality of anchor points along the optical fiber.

The optical fiber of an optical fiber retaining device can contain a fiber grating, particularly a fiber Bragg grating, located between the two anchor points. The optical fiber of a retaining device can contain a fiber grating between one or more anchor points. The fiber grating can be a fiber Bragg grating or more specifically a Long Period Grating.

The invention provides an optical sensor comprising a fiber retaining device of this invention and a fixture that holds a first fiber holder and second fiber holder with their axial bores aligned, wherein at least a portion of said fixture is elastic with respect to expansion, compression or both along the longitudinal axis; and wherein one or more optical properties of the optical fiber varies when subjected to axial strain. The optical sensor of the invention can be a device for measuring strain, measuring displacement, measuring temperature, measuring pressure, or measuring acceleration.

The invention also provides a method for measuring strain in an optical fiber which employs the optical sensor of this invention.

The invention further provides a method for mounting a optical fiber having a protective coating in a fiber holder which comprises the step of providing a glass or metal seal between the fiber holder and the coated optical fiber. The glass or metal seal can be formed within a seal-retaining cavity formed at least in part within a bore or slot in the fiber holder. In a specific embodiment, he optical fiber extends entirely through the bore or slot of the fiber holder.

Other aspects of the invention will be clear on review of the following detailed description and drawings.

### BRIEF DESCRIPTION OF THE DRAWINGS

FIG. 1A is a plan-view schematic drawing illustrating a fiber holder.

FIG. 1B is cross-sectional view of one embodiment of a fiber holder of FIG. 1A in which the axial bore of the holder has two portions of differing diameter resulting in the formation of a ledge.

FIG. 1C is a cross-sectional view of additional embodiments of a fiber holder of FIG. 1A. In one embodiment, the axial bore of the holder is a uniform cylinder and in another embodiment the axial bore of the holder is tapered.

FIG. 1D is a cross-sectional view of additional embodiments of a fiber holder of FIG. 1A. The figure illustrates two different shapes for the axial bore of the holder.

FIG. 2A is a plan-view schematic drawing illustrating an alternative design of a fiber holder. In this case, the optical fiber is positioned in an axial slot or channel and the walls of the slot or channel are shaped to form a cavity for receiving seal material.

FIG. 2B is a cross-sectional view of one embodiment of a fiber holder of FIG. 2A.

FIG. 3A is a plan-view schematic drawing illustrating a strain sensor employing a fiber holder of FIG. 1A. Portions of outer elements are removed to provide a view of internal elements of the device.

FIG. 3B is an expanded view of the optical fiber of the strain sensor of FIG. 3A schematically illustrating fiber one or more Bragg gratings in the fiber.

FIG. 4 is a cross-sectional schematic view of a portion of the strain sensor of FIG. 3A showing the positioning of the fiber holder within a metal ferrule.

FIG. 5 is a graph comparing wavelength drift as a function of time of a strain sensor of this invention (MOI, having a polyimide-coated silica fiber, low temperature sealing glass in a stainless steel fiber holder) to fiber optic-based strain gages of three different manufacturers (V1, V2 and V3). In all three strain gauges (V1-3), the fiber attachments or anchors are made employing an adhesive, such as an epoxy. In V1 and V3 the adhesive attachment is made to bare fiber. In V2 the adhesive attachment is made to fiber carrying a protective coating.

FIG. 6 is a graph of the results of a life-cycle test as described below of a strain sensor as in FIG. 3A. Time is in units of test cycles. The sensor was tested for 25,476,300 cycles and showed no signs of failure or drift due to fatigue.

### DETAILED DESCRIPTION OF THE INVENTION

The present invention provides a method of holding an optical fiber within the mechanical mount of an optical sensor in such a way as to minimize or prevent the fiber from slipping when tension is applied to the fiber and the sensor is exposed to temperature and humidity. The invention also provides optical fiber retaining devices and optical sensors in which one or more optical fiber is mounted in the device employing the optical fiber retaining devices of this invention. The invention further provides optical fibers, particularly those retaining a protective coating, mounted in fiber holders of this invention in which the fiber is mounted in and mechanically coupled to the holder employing a seal formed from glass or metal solder. Glass sealing techniques are commonly used to form a hermetic seal around fiber passing through a hole in a metal package. In these applications the fiber is stripped of its polymer coating and the glass seal is formed between the fiber and metal package. The stripping and sealing process often causes damage to the fiber surface resulting in weakening of the fiber.

The approach used in this invention preferably leaves the protective coating of the fiber in place to protect the fiber from surface damage. In one embodiment, the process uses a low temperature glass to form a seal directly over the fiber coating and anchor the fiber to the metal housing. The fiber coating prevents surface damage to the fiber surface, and also provides some strain relief in the area where the fiber exits the glass seal. By leaving the coating intact, the fiber retains most of its tensile strength. If the fiber coating is a polymer such as polyimide, the seal will not be fully hermetic; however, this is not required for most sensor applications,

Two types of glass to metal seals can be employed to anchor the fiber to the metal housing: Matched, and Compression seals. Matched seals utilize sealing glasses and metal holder having coefficients of thermal expansion (CTE). that are substantially matched. For use herein, the term “substantially matched” with respect to CTE means that the CTEs of different materials differ from one another by at most ±15%. A material having a CTE of 7 ppm/C (μm/m K or 10⁻⁶/K) is substantially matched to a material having a CTE of 7±1.05 ppm/C. In a specific embodiment, materials having a 10% or less or a 5% or less difference in CTE are employed. A matched seal depends on the formation of a chemical bond between the sealing glass and the oxide present on the surface of the metal. Two materials in which the CTEs differ by more than 15% are not substantially matched.

In contrast, compression seals take advantage of differences in the CTE's of the sealing material (e.g., glass) and the holder material (e.g., metal) to form a compression seal. Compression seals are designed with staggered CTEs. A low CTE fiber is surrounded by a higher CTE sealing glass, which is in turn surrounded by a higher CTE metal. For example, a fiber: with CTE of 1 ppm/° C.; a glass seal material with CTE of 7 ppm/° C. and Stainless Steel Fiber mounting disk with CTE of 16 ppm/° C. provides a seal with staggered CTEs. As the assembly cools from the sealing temperature, the metal contracts around the sealing glass which, in turn, contracts around the fiber resulting in large compressive stress around the fiber. Some chemical bonding also occurs in a compression seal. The seals employed in the present invention are preferably compression-type seals which take advantage of the additional holding force provided by the compressive forces. The terms greater than (or higher than) or less than (or lower than) as applied to differences in CET values refer to differences that are preferably outside the range of substantially matching, i.e., where the difference in CETs are greater than ±15%.

Sealing glasses are generally available with softening points between 250 C and 1000 C. Preferred sealing glasses are those that have a softening point that is less than the melting temperature of the material that is used fro the protective coating of the optical fiber. In specific embodiments, low-temperature sealing glasses (i.e., those having a softening point of 300C or less are employed with resin-coated optical fibers (e.g., polyimide-coated fibers which are typically rated to 300 C continuous and 400 C short term). Typical resin fiber coatings include polyimide, carbon/polyimide. Fiber protective coating may also be metal coatings, including coatings of copper, aluminum or gold. The present invention is compatible with these coatings.

When a metal such as copper or gold or metal alloy is used as a protective coating on the optical fiber, a metal alloy solder comprising lead, tin, silver, indium, gold, or copper may be used as the sealing material to secure fiber in fiber holder. A variety of metal alloy solders that can be used in the invention are known in the art.

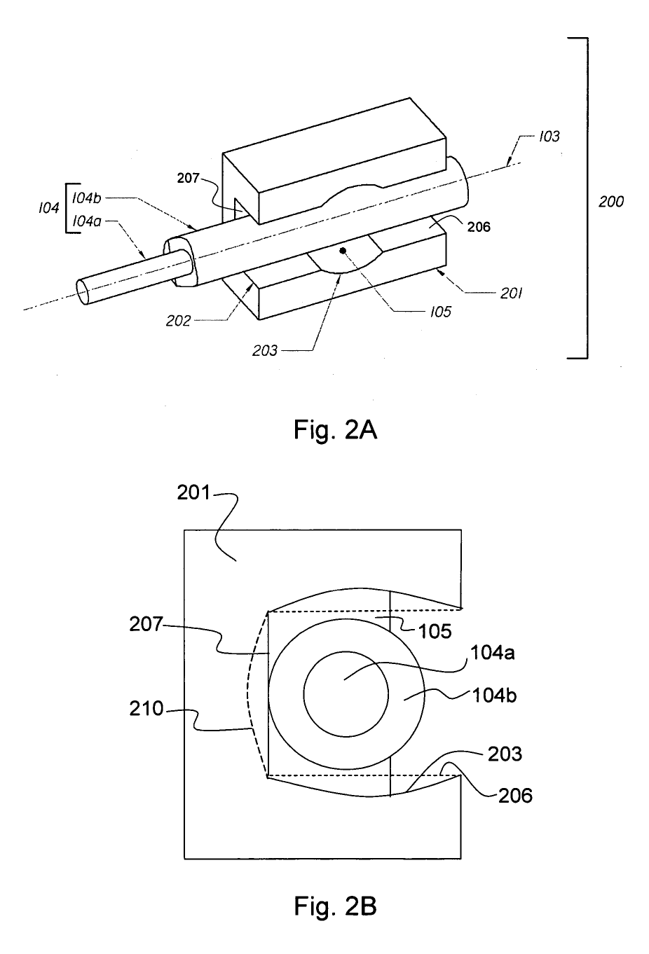

Fiber holders with attached optical fibers, optical fiber retaining devices and optical sensors of the present invention may be directly or indirectly incorporated into a variety of devices, including but not limited to, strain gages, extensometers, temperature transducers, pressure transducers, and accelerometers. A number of optical fiber sensor configurations are known in the art which can be employed with the fiber holders with attached optical fibers and optical fiber retaining devices to mount one or more optical fibers into or onto the optical fiber sensor. In view of the descriptions herein and what is known in the art, one of ordinary skill in the art can employ the devices herein in known optical sensor configurations or can readily adapt the devices herein for use in such sensor configurations. FIG. 3A provides an exemplary mounting of an optical fiber carrying a fiber Bragg grating into an optical fiber sensor configuration.

An optical fiber sensing system comprises a light source, an optical fiber; a sensing element or transducer and a detector. The principle of operation of a fiber sensor is that the transducer modulates some parameter of the optical system (intensity, wavelength, polarization, phase, etc.) which gives rise to a detectible change in the characteristics of the optical signal received at the detector. The optical fiber sensor can be either an intrinsic sensor where the modulation takes place directly in the fiber (where the fiber itself is the transducer) or an extrinsic sensor, where the modulation is performed by some external transducer which acts on the fiber. Fiber Bragg gratings introduced into optical fiber are exemplary transducers. Any change in the modal index or grating pitch of the fiber caused by strain or temperature will result in a shift in the characteristic Bragg wavelength. Fiber Bragg gratings are in often used in either strain or temperature sensing, especially where environments are harsh (e.g., high-EMI, high-temperature or highly corrosive). It is also possible to use fiber Bragg gratings to sense other environmental parameters such as pressure chemical reaction by using an additional transducer which in turn acts on the fiber Bragg grating.

For pressure applications the optical fiber carrying the fiber Bragg Grating can, for example be mounted to a diaphragm the shape of which is affected by pressure change. Alternatively, the fiber itself can be used as the pressure transducer where pressure acting upon the fiber grating in the fiber produces a three-dimensional strain mode.

For magnetic and electric field sensing an optical fiber carrying a fiber Bragg grating can be coated with a ferroelectrical coating. When the coated fiber is in an electromagnetic field, the field causes the grating in the coated fiber to expand or contract. For chemical sensing, an optical fiber carrying a fiber Bragg grating can be coated with a material that is affected by the presence of a particular chemical (a chemically-sensitive coating) so that the coating induces a strain within the fiber Bragg grating in proportion to the amount of chemical present or to a reaction which produces the chemical. For example, a palladium coated fiber carrying a fiber Bragg grating with palladium can be used to monitor hydrogen production. Palladium absorbs hydrogen and causes strain in the fiber grating.

Optical fiber sensor configurations, operation, use and applications of such sensors are known in the art. The following references are cited to provide details of sensor configurations in which the fiber holders and fiber retaining devices of this invention can be employed as well as details of sensor operation, use and applications: Farhad Ansari (Ed.) (1993) Applications of Fiber Optic Sensors in Engineering Mechanics, American Society of Civil Engineers;

Eric Udd (Ed.) (1995) Fiber Optic Smart Structures, John Wiley & Sons Inc.; Regis J. Van Steenkiste and George S. Springer (1997) Strain and Temperature Measurement with Fiber Optic Sensors, Technomic Publishing Co; Farhad Ansari (Ed.) (1998) Fiber Optic Sensors for Construction Materials and Bridges, Technomic Publishing Co; Raymond M. Measures (2001) Structural Monitoring with Fiber Optic Technology, Academic Press; Jose Miguel Lopez-Higuera (Ed.) (2002) Handbook of Optical Fibre Sensing Technology, John Wiley & Sons Inc.; Optical Fiber Sensor Guide Fundamentals and Applications (2005) Micron Optics available at http://www.micronoptics.com/pdfs/; Morey W. et al., “Recent Advances in Fiber Grating Sensors for Utilitiy Industry Applications”, Proc. SPIE vol. 2594, 1995; Kashyap, R., “Photosensitive Optical Fibers: Devices and Applications”, Op. Fiber Tech., Vol. 1, pp 17-34, 1994; Morey, W. W., Meltz, G., and Glen, W. H., “Fiber Optic Bragg Grating Sensors”, SPIE Proc., Vol. 1169, pp 98-107, 1989; G. Meltz, “Overview of fiber grating-based sensors,” Proc. SPIE, Distributed and Multiplexed Fiber Optic Sensors VI Denver, Colo., vol. 2838, pp. 1-21, 1996; Patrick, H. J.; Williams, G. M.; Kersey, A. D., Pedrazzani, J. R., Vengsarkar, A. M. “Hybrid fiber Bragg grating/long period fiber grating sensor for strain/temperature discrimination,” Photonics Technology Letters, IEEE, Volume 8, Issue 9, September 1996 page(s):1223-1225 and More, W. W., “Development of Fiber Bragg Grating Sensors for Utility Applications”, EPRI, Report TR-105190, September 1995.

The following definitions apply herein:

“Creep” refers to a slow; change in the relative position of two objects or the deformation of a material when subjected to pressure, elevated temperatures or high humidity.

“Elastic” refers to the capability of a material or object, such as a device or device component, to increase or decrease in size with respect to one or more physical dimensions. Elastic materials may be extensible, compressible or both. Elasticity refers to a characteristic of a material, object, device or device component having elasticity.

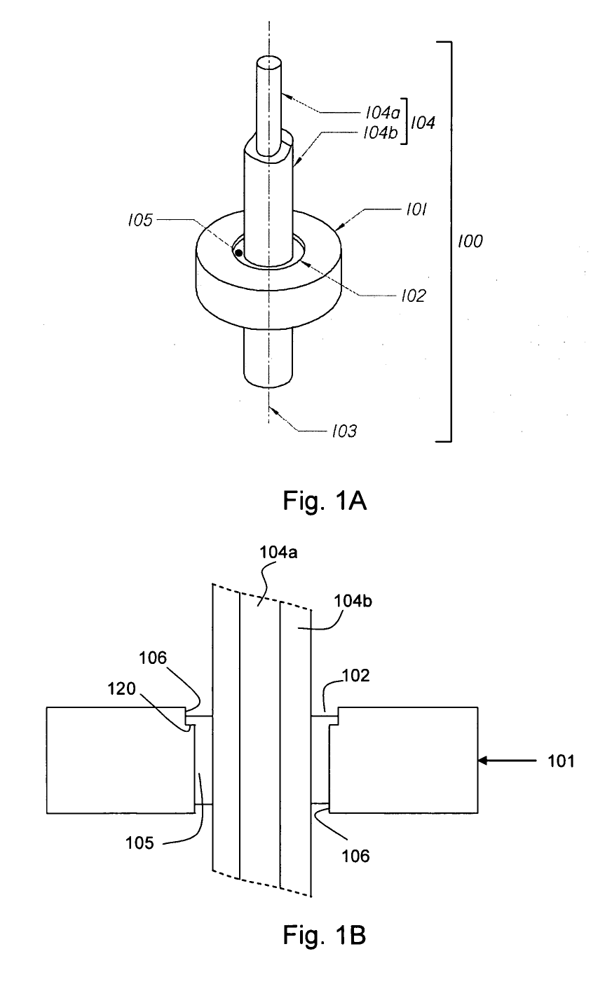

“Glass seal,” “sealing glass,” and “glass sealing material” refer to low melting temperature glass materials commonly used to form an insulating seal around pins passing through metal hermetic electronic packages. Sealing glass is often combined with various binders and viscosity modifiers to improve flow and wetting properties during the sealing process. Sealing glass appropriate for use in forming the seals of this invention can be in the form of preforms in various desirable shapes which are available commercially. In a specific embodiment, glass preforms having the following properties can be employed: glass transition temp 225° C.; softening point 276° C.; and CTE 7.5 ppm/° C. Glass preforms having OD=0.044 in, ID=0.016 in, and Length=0.03 in can be used for example in the ferrule holder exemplified in FIG. 1A.

“Optical fiber” refers most generally to any form of optical fiber having a core and a cladding as is known in the art. The methods and devices of this invention are useful in anchoring fibers made of glass (Silica) to metal fiber holders. Optical fibers useful in sensing applications include single-mode and multiple-mode fibers. Optical fibers useful in the invention include those having a uniform cladding diameter as well as those having variations in cladding diameter. Where an optical fiber having variations in cladding diameter is employed in a device herein, those variations are not the sole mechanism employed to anchor or attach the optical fiber to or within a fiber holder.

The optical fiber of this invention is preferably coated optical fiber having a protective coating along the outer surface of the fiber which protects the fiber from damage. The presence of the protective coating increases the operational lifetime of the optical fiber. Typical fiber coatings which are non-metallic include, resins, polymers or mixtures of such materials with carbon, for example, among others, polyimide, carbon/polyimide and carbon-silicone-PFA (perfluoroalkoxyethylene). Protective coatings also include metal coatings, such as copper, aluminum and gold. For sensor applications, optical fibers can contain one or more fiber gratings, such as fiber Bragg gratings which function as transducers.

A fiber Bragg grating (FBG) is a wavelength-dependent filter/reflector formed by introducing a periodic refractive index structure within the core of an optical fiber. Whenever a broad- spectrum light beam impinges on the grating, a portion of its energy is transmitted through the fiber, and another portion will be reflected. The reflected light signal will be very narrow and will be centered at a characteristic Bragg wavelength which corresponds to twice the periodic unit spacing. Conventional FBG have grating periods of the order of a few hundred nanometers. A long-period Bragg grating (LPG, A. M. Vengsarkar et al., “Long-period fiber Bragg gratings as band-rejection filters”, J. Lightwave Technol. 14, 58 (1996)) with periods of the order of hundreds of microns and which are a few centimeters long can also be employed in sensor applications and can be employed in the devices of this invention.

Any change in the modal index or grating pitch of the fiber caused by strain or temperature will result in a Bragg wavelength shift. Strain can be measured using sensors having an optical fiber having an FBG by properly mounting the optical fiber on or embedding it into a substrate of interest. One of the advantages of this technique is the fact that the detected signal is spectrally encoded, so that transmission losses in the fiber are of no concern. Strain shifts the characteristic Bragg wavelength by physically increasing or decreasing the grating spacing by mechanical strain and by changes in the refractive index due to the strain optic effect. For axial loads, the wavelength change is typically about 1.2 pm per microstrain, or 12 nm for 1% strain.

Fiber gratings with an aperiodic refractive index structure can also be employed in optical fibers and optical sensors of this invention. For example, chirped fiber gratings can be used. Chirped fiber gratings are of particular interest for intragrating sensing.

“Unitary body” refers to a body or object made up of a continuous single material or made up of separate components that are operationally attached to each other. Unitary bodies do not comprise physically separated, discontinuous elements. Preferred unitary bodies are fabricated from a single material. However, a unitary body may comprise a plurality of components that are connected by one or more fasteners, such as weld joints, glue, epoxy, screws, bolts, clamps, clasps, or any known equivalent of these.

“Coefficient of thermal expansion” (CET) refers to the fractional change in length or volume of a material resulting from a given change in temperature. Usually expressed in terms of length/length/unit temperature (m/m/° C.).

“Perpendicular to a longitudinal axis” refers to a direction that is defined by an axis that is positioned at an angle of ninety degrees relative to the longitudinal axis. Similarly, “parallel to a longitudinal axis” refers to a direction that is defined by an axis that is positioned at an angle of zero or 180 degrees relative to the longitudinal axis. It will be apparent to one of ordinary skill in the art that some deviation from perpendicular or parallel can be tolerated in devices and device components herein so long as the operation of the device or device element is not significantly detrimentally affected by the deviation.

Reference in the specification to “a preferred embodiment,” “an alternative embodiment” or “an exemplary embodiment” means that a particular feature, structure, or characteristic set forth or described in connection with the embodiment is included in at least one embodiment of the invention. Reference to “a preferred embodiment,” “an alternative embodiment” or “an exemplary embodiment” in various places in the specification do not necessarily refer to the same embodiment.

The invention is further described by reference to the drawings in which like numerals indicate like elements and the same number appearing in more than one drawing refers to the same element.

FIG. 1 illustrates an exemplary embodiment of an optical fiber retaining device of the present invention capable of holding an optical fiber under tension with little or no creep between the fiber and fiber holder. The illustrated fiber holder (100) comprises unitary body (101). Unitary body (101) has an axial bore extending along longitudinal axis (103) formed by an inner cylindrical wall (106) of the fiber holder. Optical fiber (104) consisting of silica fiber (core and cladding) (104a) and protective coating (104b) passes through axial bore in fiber holder (100) and extends along longitudinal axis (103). Optical fiber (104) is retained in fiber holder (100) with seal (105) formed from glass (or alternatively of metal solder). A glass seal material, such as in the form of a glass preform, is heated to its melting temperature during the sealing process and forms the seal disposed around the fiber coating (104b) on solidfication. The seal (105) is captured inside the cavity formed between the inserted optical fiber and the axial bore (102) and fills the void between the fiber coating (104b) and the inner wall of the fiber holder (106) forming a seal between the optical fiber and the fiber holder which mechanically couples, anchors and attaches the fiber to the fiber holder.

Cavity 102 is the cavity which holds and retains seal forming material and which at least in part defines the shape of the seal formed between the fiber and the holder. In an exemplary embodiment, the coefficient of thermal expansion of the fiber holder (101) is greater than that of the sealing material used to form seal (105), which in turn has a coefficient of thermal expansion greater than that of the fiber (104). As the assembly cools from elevated sealing temperature, the sealing material (105) contracts at a faster rate than the fiber (104) causing compressive stresses between the sealing glass and the fiber. At the same time the axial bore (102) in the fiber holder (100) contracts at a faster rate than the sealing glass (105) causing compressive stresses between fiber holder (100) and glass seal (105). Because the protective coating on the fiber is typically very thin (10-20 μm) compared to the fiber (diameter of bare fiber ˜125 μm), the CET of the protective coating does not significantly affect compression of the seal.

In a specific embodiment, illustrated in FIG. 1B, the wall (106) of the axial bore of the holder (101) contains ledge 120 formed by a variation in the diameter of the bore. The presence of the ledge creates a corresponding lip in seal 105. The lip structure in the seal formed against the ledge structure in the bore provides additional mechanical strength in the seal and increased resistance to forces applied parallel to the axis and in the directions downward (as illustrated in FIG. 1B) from the lip/ledge engagement. This configuration decreases the possibility of relative motion of the bore and fiber when the fiber is moved downward (by reference to FIG. 1A)

Additional configurations of the seal and bore structure of a fiber holder are illustrated in FIGS. 1C and 1D. In FIG. 1C a bore of uniform diameter is illustrated (solid lines 106). An alternative, tapered bore is illustrated in dashed lines 106a. The tapered bore will provide increased resistance to a downward (as illustrated in FIG. 1B) motion of the fiber relative to the holder (101). Additional alternative bore structures in which the walls of the bore are indented are illustrated in FIG. 1D. Dashed lines 110a illustrate a curved indented bore and dashed lines 100b illustrate a v-shaped indentation. The walls forming the axial bore of holder 101 can be indented having one or more indented regions or carry one or more protrusions. The term “bore” as used herein does not imply any particular structure of the inner walls of the holder that form the bore. The inner walls of the holder may form a bore structure that is symmetrical with respect to the longitudinal axis 103 or the walls may contain indentations or protrusions that are asymmetrical with respect to that axis. In specific embodiments, the walls of the holder contain a single indentation of protrusion that is symmetrical with respect to axis 103. In other embodiments, the walls of the holder contain a plurality of indentations or protrusions that can be symmetrically disposed or asymmetrically disposed with respect to axis 103.

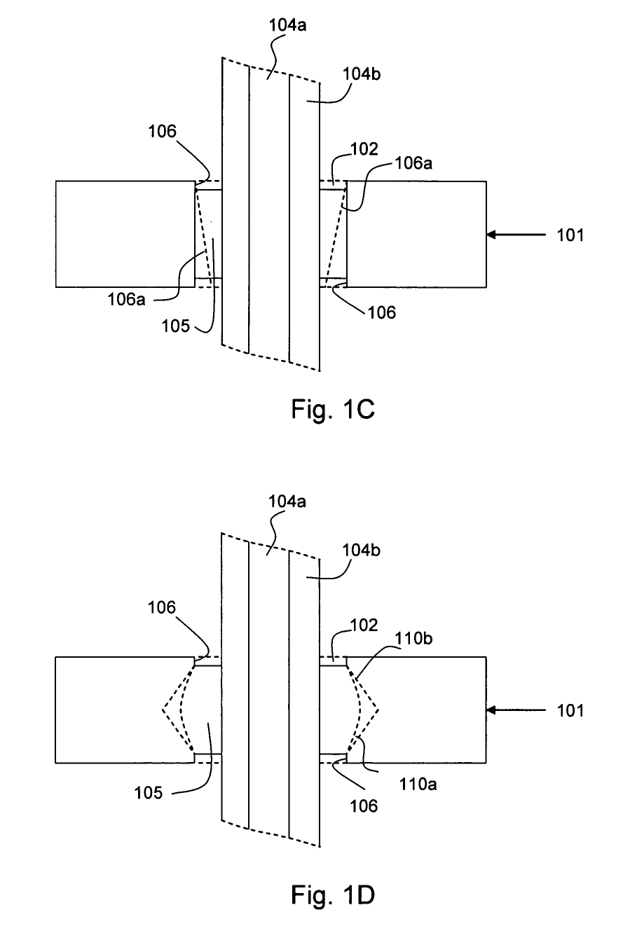

FIG. 2A illustrates an alternative embodiment of a fiber holder (100). The illustrated fiber holder (200) comprises unitary body (201). Unitary body (201) has a longitudinal slot (202) extending parallel to longitudinal axis (103) sized and shaped for receiving an optical fiber. Slot (202) is illustrated as being formed by three inner walls of the holder (i.e., two side walls 206 and a bottom wall 207). Slot (202) is illustrated as having a rectangular shape, but may have various other shapes, e.g., cylindrical. Optical fiber (104) consisting of silica fiber (104a) and protective coating (104b) is positioned in slot (202) and extends along longitudinal axis (103). Unitary body (201) has a cavity (203) perpendicular to longitudinal axis (103) formed by indenting or widening a portion of the side walls of the slot. Cavity (203) forms a pocket in which the sealing material can be placed to form seal 105 between the fiber and the fiber holder. Cavity (203) contains the seal material as it melts and confines it preferably in such a way that the walls forming cavity 203 apply compressive stresses against the fiber (104) as it cools. Cavity 203 is the cavity which holds and retains seal forming material and which at least in part defines the shape of the seal formed between the fiber and the holder. The seal material is captured inside cavity (203) and fills the void between the fiber coating (104b) and the walls that form cavity (203).

In an exemplary embodiment, the coefficient of thermal expansion of the fiber holder (200) is greater than that of the sealing materials, e.g., sealing glass, which forms seal (105), which in turn has a coefficient of thermal expansion greater than that of the fiber (104). As the assembly cools from elevated sealing temperature, the sealing material in cavity 203 contracts at a faster rate than the fiber (104) causing compressive stresses between the sealing material forming seal 105. At the same time, the walls of hole (203) in the fiber holder (200) contract at a faster rate than the sealing material causing compressive stresses between fiber holder (200) and seal (105). A better illustration of seal 105 is provided in FIG. 2B.

FIG. 2B is a cross-section of the holder of FIG. 2A at the indentation which forms cavity 203. This figure illustrates shaping of one or more walls of the slot to create cavity 203. Two different cavity configurations are illustrated in FIG. 2B. In a first configuration illustrated by solid lines 209 (indentations in side walls 206) and wall 207, the cavity is shaped by indented walls 209 and non-indented wall 207. In a second configuration illustrated by solid lines 209 and dashed line 210, the cavity 203 is formed by indentations in walls 206 and 207. The walls of the slot (207 and 206) can contain a single indentation (as illustrated in FIG. 2B), a single protrusion (not show) or a plurality of indentations or protrusions which form the shape of cavity 203 which in turn at least in part determines the shape of seal 105.

As illustrated in FIG. 2B, seal 105 is formed between the fiber in the holder slot 202 and the walls of the slot to thereby mechanically couple the fiber and the holder.

The seals formed within the holders of the devices of this invention provide for a durable mechanical coupling of the fiber and the holder which minimizes or avoids creep (i.e. relative motion of the fiber and the holder) which is particularly beneficial in sensor applications.

In the preferred embodiments illustrated in FIGS. 1A and 2A, the unitary body is preferably fabricated from a material having a coefficient of thermal expansion higher than that of the glass seal material. For example, use of stainless steel alloys, preferably having a linear coefficient of thermal expansion of about 9.9 ppm/° C., in the fabrication of the unitary body is desirable for use with glass sealing material having a linear coefficient of thermal expansion of about 7.1 ppm/° C. Alternatively, use of low expansion electronic alloys, such as the iron/nickel alloy Invar™ (Imphy S. A. Corp., Paris France) and the iron-nickel-cobalt alloy Kovar™ (CRS Holdings, Inc., Wilmington Del.) in the fabrication of the unitary body is desirable for use with higher temperature sealing glasses having a lower coefficient of thermal expansion.

The fiber holders with attached optical fibers (100 and 200) shown in FIGS. 1A and 2A are examples of a means of anchoring the fiber of the present invention. It will be appreciated by those of ordinary skill in the art that various fiber holder structures can provide a hole or cavity for receiving an optical fiber and for receiving sealing glass. In the present invention any fiber holder configuration is employable that provides a cavity through which the fiber can pass and in which the liquefied seal material can be contained. The cavity that confines the seal material may be of any geometry that will confine the seal material as it expands during cooling and preferably cause compressive stresses to develop in the seal.

FIG. 3A illustrates an exemplary embodiment of a strain sensor (300) utilizing fiber holders (101) of the type illustrated in FIG. 1A. In a preferred embodiment, two fiber holders (101) are attached to a single piece of optical fiber separated by a distance. One or more optical properties of the length of fiber (305) located between the two fiber holders (101) vary when the fiber is subjected to axial strain. In preferred embodiments, the length of fiber (305) located between to the fiber holders contains one or more fiber gratings, particularly fiber Bragg gratings, that respond to axial strain by shifting the center wavelength of the reflected optical spectrum. FIG. 3B schematically illustrates one or more Bragg gratings in the fiber of the sensor of FIG. 3A.

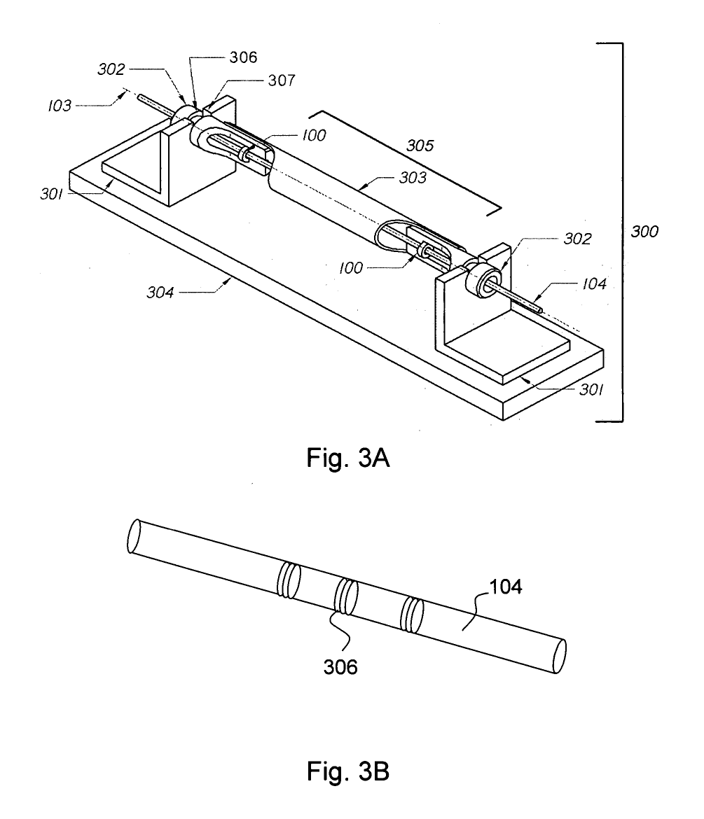

For ease of handling and mounting, fiber holder (101) is mounted inside ferrules (302). Protective cover tube (303) slides over ferrules (302) and protects the optical fiber. Ferrules (302) are free to slide within protective tube (303) along longitudinal axis (103). In specific embodiments, mounting brackets (301) fasten to ferrules (302) and may be bolted, welded, glued, or fastened by any other appropriate means to test specimen (304). For example, each ferrule (302) can be provided with a groove (306) which engages a corresponding slot (307) in mounting backet 301 to attach or fasten the ferrules between the brackets. (The engagement of groove (306) with mounting bracket slot (307) is further illustrated in FIG. 4.) Test specimen 304 is mechanically coupled to brackets 301 which in turn are mechanically coupled to ferrules 302 which in turn are mechanically coupled to holders1lo which in turn are mechanically coupled at two locations on optical fiber 104. Strain imparted to test specimen 304 is detectable as strain imparted to the mounted optical fiber.

Protective tube (303) of the sensor of FIG. 3A may alternatively be fabricated from a compliant material that will stretch as strain is applied to the sensor allowing protective tube (303) to be bonded directly to ferrules (302). In this configuration it is not necessary for protective tube (303) to slide over ferrules (302).

It will be appreciated by one of ordinary skill in the art that in operation the sensor of FIG. 3A is optically coupled to a light source and detector as is known in the art.

FIG. 4 is a schematic illustration of a cross-section of an exemplary ferrule configuration of a sensor of FIG. 3A. FIG. 4 illustrates one exemplary way in which a fiber holder (100) anchored to a coated optical fiber (104) via seal (105) is mounted into a strain sensor. Ferrule 302 has an axial bore (402) with an inner (402a) and an outer portion (402b) of different diameter such that a shoulder (404) is formed within the axial bore (402) of the ferrule. The inner smaller diameter portion of the axial bore (402a) is sized to receive the coated optical fiber. The outer larger diameter portion of the axial bore (402b) is sized and shaped to receive the fiber holder (100) (e.g., the circular fiber holder of FIG. 1). Fiber with attached fiber holder (100) is passed through the axial bore of the ferrule such that fiber holder engages shoulder 404. As illustrated in FIG. 3A a second fiber holder (100) is attached and sealed to the coated optical fiber using a glass seal and spaced apart a selected fiber length from the first fiber holder. The second fiber holder is positioned on the fiber to engage a shoulder (404) formed in the second ferrule of the strain sensor (as shown in FIG. 3A). The fiber holders are spaced apart such that the optical fiber between the two fiber holders is held in place in the sensor by tension between the shoulders in the axial bores of the two ferrules of the sensor. The spaced apart fiber holders sealed to the optical fiber may alternatively be bonded to the two ferrules, respectively, using an appropriate adhesive, such that the fiber between the two fiber holders is positioned between the two ferrules. Alternatively, the fiber holders may be welded or soldered to the ferrules or mechanically fastened to the ferrules employing various fastening devices such as screws, bolts, clamps and the like. Mechanical stops (not shown) can be built into the sensor assembly to prevent the fiber from breaking. The actual tension in the fiber is set by adjusting the spacing of the mounting brackets 301.

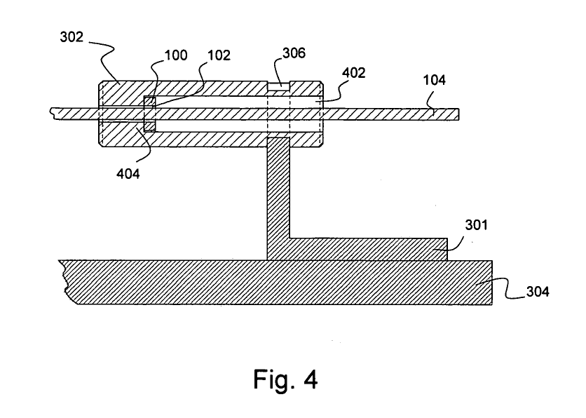

In an exemplary embodiment, a strain sensor having a stainless steel fiber holder, a polyimide coated silica fiber, and low temperature sealing glass exhibits considerably less wavelength drift when exposed to elevated temperatures and high humidity than comparable sensors using conventional methods of mounting fiber. As illustrated in the graph of FIG. 5, the performance of an exemplary embodiment of a strain gage of this invention is compared with strain gages from 3 different manufactures. In all three strain gauges (V1-3), the fiber attachments or anchors are made employing an adhesive, such as an epoxy. In V1 and V3 the adhesive attachment is made to bare fiber. In V2 the adhesive attachment is made to fiber carrying a protective coating. All gauges were pretensioned and held at constant strain while exposed to 75° C. and 75% relative humidity. Ideally the wavelength should remain constant. The gage of the current invention displayed much improved wavelength stability compared with the gages of 3 other manufactures.

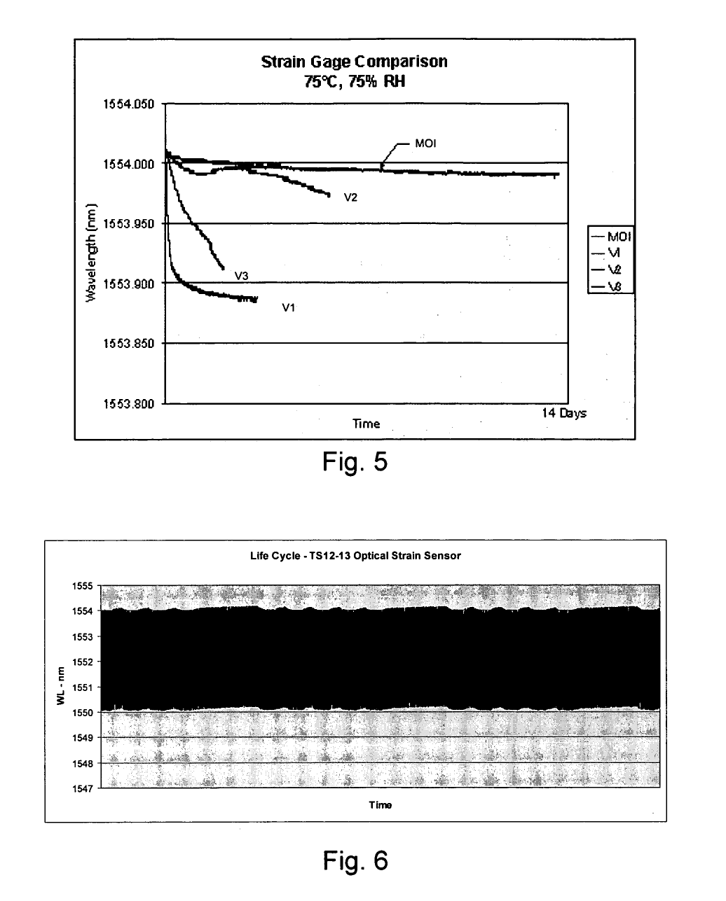

A life cycle test was performed to demonstrate the robustness of the strain sensor of this invention. For this test, a sensor as illustrated in FIGS. 3A and B was bolted to a test fixture having one fixed and one moving support. The moving support is motor driven and translates in a direction parallel to the axis of the sensor at a rate of 6 Hz. The moving support is adjusted so that it imparts a strain on the sensor that varies between 0 and 2000 micro-strain. The results of this life cycle test are shown in FIG. 6 where time is in cycles. The sensor was tested for a total of 25,476,300 cycles and showed no signs of failure or drift due to fatigue. The graph of FIG. 6 shows the wavelength of the sensor oscillating between a lower and upper bound as the applied strain oscillates between 0 and 2000 micro-strain. The slight variations in the upper and lower bounds are due to temperature variations during the test. Any slippage or creep present at the fiber attach points, would result in a zero shift displayed as a downward trend in the data. No such zero shift is observed in FIG. 6 indicating that there was no measurable creep in this strain sensor over the testing period.

When a Markush group or other grouping is used herein, all individual members of the group and all combinations and possible subcombinations of the group are intended to be individually included in the disclosure. Every combination of components described or exemplified herein can be used to practice the invention, unless otherwise stated. One of ordinary skill in the art will appreciate that methods, device elements, and materials other than those specifically exemplified can be employed in the practice of the invention without resort to undue experimentation. All art-known functional equivalents, of any such methods, device elements, and materials are intended to be included in this invention. Whenever a range is given in the specification, for example, a temperature range, a frequency range, a time range, or a composition range, all intermediate ranges and all subranges, as well as, all individual values included in the ranges given are intended to be included in the disclosure. Any one or more individual members of a range or group disclosed herein can be excluded from a claim of this invention. The invention illustratively described herein suitably may be practiced in the absence of any element or elements, limitation or limitations which is not specifically disclosed herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

Although the description herein contains many specificities, these should not be construed as limiting the scope of the invention, but as merely providing illustrations of some of the embodiments of the invention. Each reference cited herein is hereby incorporated by reference in its entirety. However, if any inconsistency arises between a cited reference and the present disclosure, the present disclosure takes precedent. Some references provided herein are incorporated by reference to provide details concerning the state of the art prior to the filing of this application, other references may be cited to provide additional or alternative device elements, additional or alternative materials, additional or alternative methods of analysis or application of the invention. All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. One of ordinary skill in the art will appreciate that device elements, as well as materials, shapes and dimensions of device elements, as well as methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

1. An optical fiber retaining device comprising: a fiber holder having a bore or slot extending along the longitudinal axis of the fiber holder; an optical fiber that passes through the bore or slot in the fiber holder and which is oriented parallel to longitudinal axis of the fiber holder; and a glass or metal seal formed between the optical fiber and the holder which is formed at least partially within the bore or slot of the fiber holder.

2. The device of claim 1 wherein the seal is a glass seal.

3. The device of claim 1 wherein the optical fiber has a protective coating.

4. The optical fiber retaining method of claim 1 wherein the seal between optical fiber and the fiber holder is formed over the protective coating of the fiber.

5. The optical fiber retaining device of claim 1 wherein the optical fiber has a protective coating that is not removed during the sealing process.

6. The optical fiber retaining device of claim 2 wherein the glass seal material has a coefficient of thermal expansion greater than that of the optical fiber.

7. The optical fiber retaining device of claim 2 wherein the fiber holder material has a coefficient of thermal expansion greater than that of the glass seal material.

8. The optical fiber retaining device of claim 2 wherein a compression seal is formed.

9. The optical fiber retaining device of claim 2 wherein the fiber holder material has a coefficient of thermal expansion substantially matched to that of the glass seal material.

10. The optical fiber retaining device of claim 1 wherein the fiber holder is fabricated from stainless steel, Kovar, or Invar.

11. The optical fiber retaining device of claim 1 wherein the fiber holder has a seal-retaining cavity at least in part formed in the bore or slot of the holder.

12. The optical fiber retaining device of claim 1 wherein the fiber has a polyimide protective coating made of polyimide, carbon-polyimide, or carbon-Silicone-PFA.

13. The optical fiber retaining device of claim 1 wherein the fiber has a metallic protective coating made of gold, copper, or aluminum.

14. The optical fiber retaining device of claim 13 wherein the sealing material is a metal alloy.

15. The optical fiber retaining device of claim 14 wherein the sealing material is a metal alloy solder comprising lead, tin, silver, Indium, gold, or copper.

16. The optical fiber retaining device of claim 1 further comprising a second fiber holder having an bore or slot extending along the longitudinal axis of the fiber holder; wherein the optical fiber with protective coating passes through the bore or slot in the second fiber holder and is oriented parallel to the longitudinal axis of the second fiber holder; and a second glass or metal seal formed around the optical fiber and at least partially within bore or slot of the fiber holder forming a seal between the coated optical fiber and the second fiber holder wherein the first and second fiber holders are spaced apart along the optical fiber forming two anchor points along the fiber.

17. The optical fiber retaining device of claim 16 further comprising one or more additional fiber holders each having a bore or slot extending along the longitudinal axis of the fiber holder; wherein the optical fiber with protective coating passes through the bore or slot of each additional fiber holder and is oriented parallel to the longitudinal axes of each additional fiber holder; and for each additional fiber holder an additional glass or metal seal for each additional fiber holder formed around the optical fiber and at least partially within the bore or slot of the additional fiber holder forming a seal between the coated optical fiber and each of the additional fiber holders wherein the fiber holders are spaced apart along the optical fiber forming a plurality of anchor points along the optical fiber.

18. The optical fiber retaining device of claim 16 wherein the fiber contains a Bragg grating located between the two anchor points.

19. The optical fiber retaining device of claim 17 wherein the fiber contains a Bragg grating between one or more anchor points.

20. The fiber retaining device of claim 16 wherein the fiber contains a Long Period Grating located between the two anchor points.

21. An optical sensor comprising a fiber retaining device of claim 16 and further comprising a fixture that holds first fiber holder and second fiber holder with their axial bores aligned, wherein at least a portion of said fixture is elastic with respect to expansion, compression or both along the longitudinal axis; and wherein one or more optical properties of the optical fiber varies when subjected to axial strain.

22. The optical sensor of claim 21 wherein the seals are glass seals.

23. The optical sensor of claim 21 wherein the seals are formed from metal alloy solder.

24. The optical sensor of claim 21 which is a device for measuring strain.

25. The optical sensor of claim 21 which is a device for measuring displacement.

26. The optical sensor of claim 21 which is a device for measuring temperature.

27. The optical sensor of claim 21 which is a device for measuring pressure.

28. The optical sensor of claim 21 which is a device for measuring acceleration.

29. A method for measuring strain in an optical fiber which employs the optical sensor of claim 21.

30. A method for mounting a optical fiber having a protective coating in a fiber holder which comprises the step of providing a glass or metal seal between the fiber holder and the coated optical fiber.

31. The method of claim 30 wherein the glass or metal seal is formed within a seal-retaining cavity formed at least in part within a bore or slot in the fiber holder.

32. The method of claim 31 wherein the optical fiber extends entirely through the bore or slot of the fiber holder.
